(19) United States
(12) Patent Application Publication
(10) Pub. No.: US 2010/0198464 A1
(43) Pub. Date: Aug. 5, 2010

(54) DIAGNOSABLE MAGNETIC SWITCH ASSEMBLY

(75) Inventors: Randall T. Jones, Shaker Hts, OH (US); Bo Lu, Westfield, IN (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/696,086

(22) Filed: Jan. 29, 2010

Related U.S. Application Data
(60) Provisional application No. 61/148,500, filed on Jan. 30, 2009.

(51) Int. Cl. A47C 7/62; H01H 36/00

(52) U.S. Cl. 701/45; 335/205

(57) ABSTRACT

A diagnosable magnetic switch assembly and method for determining a seat occupant. A network in the assembly includes a resistor in series with a magnetic switch, and a resistor in parallel with the series combination. Such an arrangement provides distinct assembly resistance values when the magnetic switch is open or closed, and thereby provides a means for diagnosing the operational state of the diagnosable magnetic switch assembly. The diagnosable magnetic switch assembly may be included in a seat occupant indicator system that embeds the seat occupant indicator system and a magnet in a cushion of a seat assembly. When the seat assembly is occupied, the magnet is separated from the seat occupant indicator system by a sufficient distance so the seat occupant indicator system is in an open state. When an occupant sits in the seat assembly, the magnet and the seat occupant indicator system are brought closer together so that the magnetic field operate the seat occupant indicator system to a closed state. A controller measures the assembly resistance values to determine if the seat assembly is empty, occupied, or if an assembly fault state is occurring.

### CROSS-REFERENCE TO RELATED APPLICATION

This application claims the benefit under 35 U.S.C. §119(e) of U.S. Provisional Patent Application No. 61/148,500, filed Jan. 30, 2009, the entire disclosure of which is hereby incorporated herein by reference.

### TECHNICAL FIELD OF INVENTION

The invention generally relates to magnetic switches, and more particularly relates to a seat occupant indicator system.

### BACKGROUND OF INVENTION

Many vehicles such as automobiles, tractors, and construction equipment are equipped with seat occupant detectors. Such detectors are often based on some kind of switch installed in the seat that is activated to one state when the seat assembly is empty, and another state when the seat is occupied by a person. Such switches may be used as part of a seat belt reminder (SBR) system for reminding an operator or a passenger to fasten a seat belt. Some occupant detectors use air bladders that sense pressure due to the weight of the person in the seat assembly. Other occupant detectors use a mechanical switch in the seat assembly or seat cushion that is actuated by the presence of a person occupying the seat assembly. However, occupant detectors using a bladder or a mechanical switch have undesirably high cost, and make noise when activating the mechanical switch. Furthermore, if the wiring harness connected to the bladder or mechanical switch is damaged resulting in either an open circuit or a short circuit, the fault in the wiring harness may go undiagnosed. What is needed is a simple occupant detector switch that can be easily diagnosed for wiring failures.

### SUMMARY OF THE INVENTION

In accordance with one embodiment of this invention, a diagnosable magnetic switch assembly is provided. The diagnosable magnetic switch assembly comprises a first terminal and a second terminal for making electrical contact with the diagnosable magnetic switch assembly. The diagnosable magnetic switch assembly further comprises a first network and a second network. The first network is connected between the first terminal and the second terminal, and includes a first resistor having a first resistor value. The second network is connected between the first terminal and the second terminal, and includes a series arrangement of a second resistor and a magnetic switch. The second resistor has a second resistor value. The magnetic switch is operable to an open state and a closed state in response to a magnetic field corresponding to a proximity of a magnet. By this arrangement the diagnosable magnetic switch assembly exhibits an assembly resistance value indicative of at least the open state, the closed state, or an assembly fault state.

In another embodiment of the present invention, a seat occupant indicator system is provided. The seat occupant indicator system comprises a seat assembly, a diagnosable magnetic switch assembly, a magnet, and a controller. The seat assembly comprises a cushion formed of compressible material that includes a compressible region of the cushion that is compressed when an occupant is present on the seat assembly, The diagnosable magnetic switch assembly is arranged proximate to the compressible region, is operable to an open state and a closed state in response to a magnetic field, and is configured to exhibit an assembly resistance value indicative of at least an open state, a closed state, or an assembly fault state. The magnet provides the magnetic field and is arranged proximate to the diagnosable magnetic switch assembly such that when the compressible region is not compressed, the magnet has a position such that the magnetic field operates the diagnosable magnetic switch assembly to the open state, and when the compressible region is compressed, the magnet has a position such that the magnetic field operates the diagnosable magnetic switch assembly to the closed state. The controller is configured to determine the assembly resistance value and thereby indicate when a seat occupant is present or an assembly fault state exists.

In yet another embodiment of the present invention, a method of detecting a seat occupant is provided. The method of detecting a seat occupant includes the step of configuring a diagnosable magnetic switch assembly to operate to an open state and a closed state in response to a magnetic field corresponding to a proximity of a magnet and to exhibit an assembly resistance value indicative of at least an open state, a closed state, or an assembly fault state. The method also includes the step of arranging the diagnosable magnetic switch assembly and a magnet in a seat cushion to vary the magnetic field effective to operate the diagnosable magnetic switch assembly to detect the presence of a seat occupant on the seat cushion. The method further includes the steps of determining the assembly resistance value, and outputting an indication when a seat occupant is present or an assembly fault state exists.

Further features and advantages of the invention will appear more clearly on a reading of the following detail description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a cross section view of an empty seat assembly with of a diagnosable magnetic switch assembly within seat cushion in accordance with one embodiment;

FIG. 2 is a cross section view of an occupied seat assembly with of a diagnosable magnetic switch assembly within seat cushion in accordance with one embodiment;

FIG. 3 is a schematic/block diagram of a diagnosable magnetic switch assembly in accordance with one embodiment; and

FIG. 4 is a flow chart of a method to determine the presence of a seat occupant in accordance with one embodiment.

### DETAILED DESCRIPTION OF INVENTION

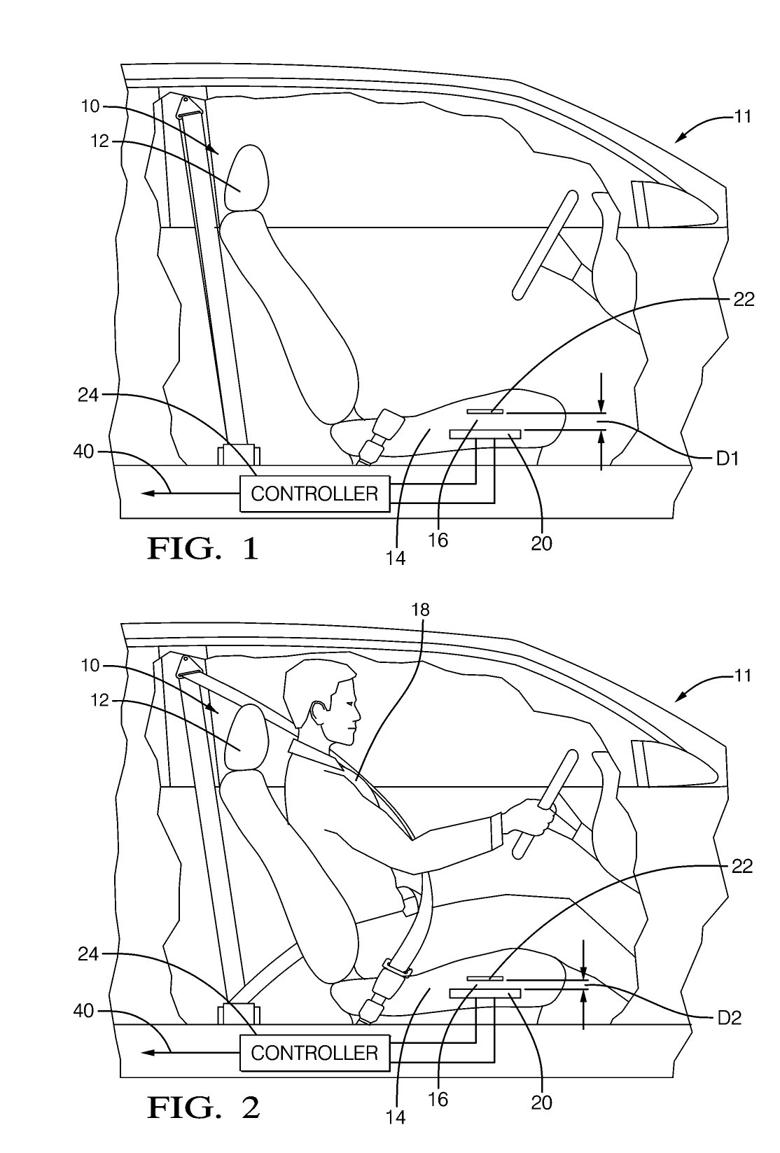

In accordance with an embodiment of a seat occupant indicator system 10, FIGS. 1 and 2 illustrate a seat assembly 12 in a vehicle 11. The system 10 may be used in a variety of vehicles such as an automobile, construction equipment, or aircraft. The indication of an occupant being present in the seat assembly 12 may be used by a seat belt reminder system or for controlling the deployment of a supplemental restraint such as an airbag. The seat assembly 12 includes a cushion 14 formed of compressible material such as foam or the like, it being understood that the intent is that there is something compressible, and that the invention is not limited to foam. The cushion 14 has a compressible region 16 that is substantially uncompressed when the seat assembly 12 is empty, and is compressed when an occupant 18 is present on the seat assembly 12. The amount of compression is dependent on a variety of factors including, but not limited to, the durometer of the material forming the seat cushion 14 and the weight of the occupant 18.

The seat assembly 12 may also include a diagnosable magnetic switch assembly 20 arranged proximate to the compressible region 16. The diagnosable magnetic switch assembly 20 is generally operable to an open state or a closed state in response to a magnetic field corresponding to a proximity of a magnet. In one embodiment, if the strength of the magnetic field impinging on the switch assembly 20 is less that a threshold, the switch assembly may operate to the open state. Similarly, if the strength of the magnetic field impinging on the switch assembly 20 is greater than a threshold, the switch assembly may operate to the closed state. In one embodiment, the diagnosable magnetic switch assembly 20 is configured to exhibit an assembly resistance value indicative of at least an open state, a closed state, or an assembly fault state. The arrangement and operation of the diagnosable magnetic switch assembly 20 is described in more detail below.

The seat assembly 12 may also include a magnet 22 for providing a magnetic field to operate the diagnosable magnetic switch assembly 20. The magnet 22 may be a permanent magnet or an electro-magnet. A permanent magnet is advantageous in that it is generally less expensive than an electro magnet and does not require a power supply. An electro-magnet is advantageous in that the magnetic field can be varied for calibration and/or diagnostic purposes.

The magnet 22 may be arranged in the seat assembly 12 to be proximate to the diagnosable magnetic switch assembly 20. As illustrated in FIG. 1, the arrangement is such that when the seat is empty, the compressible region 16 is not substantially compressed and the magnet 22 has a position such that the magnetic field operates the diagnosable magnetic switch assembly 20 to the open state. When the seat assembly 12 is empty or unoccupied, the compressible region 16 is uncompressed and the separation between the magnet 22 and the diagnosable magnetic switch assembly 20 is designated as distance D1. As illustrated in FIG. 2, when the seat assembly 12 is occupied by the occupant 18, the compressible region 16 is generally compressed by the occupant 18 so the magnet 22 and the diagnosable magnetic switch assembly 20 are generally in closer proximity as compared to when the seat assembly 12 is empty. In general, as the magnet 22 moves closer to the diagnosable magnetic switch assembly 20, the strength of the magnetic field impinging on the diagnosable magnetic switch assembly 20 increases. As such and the magnet 22 may be urged into such a position by the presence of an occupant 18 that the magnetic field operates the diagnosable magnetic switch assembly 20 to the closed state. The values of distances D1 and D2 may be empirically determined based on the durometer of the cushion 14, the strength of the magnetic field generated by the magnet 22, and the sensitivity of the diagnosable magnetic switch assembly 20.

It should be appreciated that the arrangement of the magnet 22 and the diagnosable magnetic switch assembly 20 shown in FIGS. 1 and 2 is exemplary and non-limiting. As illustrated, the seat cushion 14 is depicted as being formed of a single material where the magnet 22 and the diagnosable magnetic switch assembly 20 are molded into the foam forming the seat cushion 14. Alternately, the seat cushion 14 may be formed of various layers of material, each possibly having a different durometer. In such an embodiment the magnet 22 and the diagnosable magnetic switch assembly 20 may be placed as the layers are assembled to form the cushion 14. Alternately, the diagnosable magnetic switch assembly 20 may be arranged to be between the occupant 18 and the magnet 22. Also, alternate arrangements may have either the magnet 22 or the diagnosable magnetic switch assembly 20 at the upper or lower surface of the seat cushion 14.

The seat occupant indicator system 10 may also include a controller 24 configured to measure or determine the assembly resistance value and output a signal 40 indicating when a seat occupant is present, the seat is empty, or an assembly fault state is indicated based on the assembly resistance value. As used herein, an assembly fault state is indicated when the assembly resistance value is not a value indicative of either the seat being empty seat or a value indicative of the seat being occupied. The controller 24 may include a microprocessor or other control circuitry as should be evident to those skilled in the art. The controller may include memory, including non-volatile memory, such as electrically erasable programmable read-only memory (EEPROM) for storing one or more routines, thresholds and captured data. The one or more routines may be executed by the microprocessor to perform steps for determining the assembly resistance value and outputting an indication that a seat occupant is present or an assembly fault state exists. For one embodiment of the diagnosable magnetic switch assembly 20, the controller 24 may be configured to indicate that the diagnosable magnetic switch assembly is in the open state when the assembly resistance value is substantially equal to a first resistor value, indicate that the diagnosable magnetic switch assembly 20 is in the closed state when the assembly resistance value is substantially equal to a parallel combination of the first resistor value and a second resistor value, and indicate a fault condition when neither the open state nor the closed state is indicated.

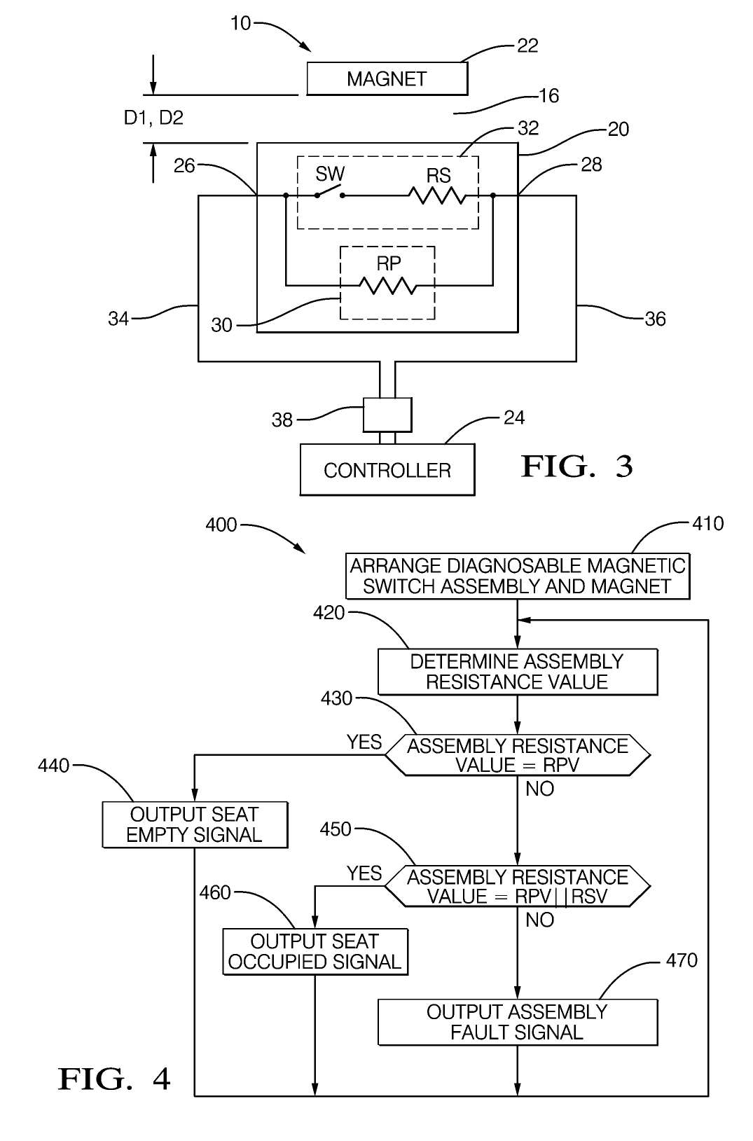

FIG. 3 illustrates a schematic/block diagram of one embodiment of a seat occupant indicator system 10. The diagnosable magnetic switch assembly 20 includes a first terminal 26 and a second terminal 28 for making electrical contact with the controller 24 and a network of electrical components within the diagnosable magnetic switch assembly 20. The network of components within the diagnosable magnetic switch assembly 20 may be segregated into a first network 30 and a second network 32. Separating the components into two networks is generally for the purpose of simplifying the explanation of the diagnosable magnetic switch assembly 20. The first network 30 is connected between the first terminal and the second terminal and includes a first resistor RP having a first resistor value RPV. By this arrangement, the first network 30 provides a first electrical path having a resistance value that is generally independent of the state of the magnetic switch SW. The second network 32 is also connected between the first terminal 26 and the second terminal 28 and includes a series arrangement of a second resistor RS having a second resistor value RSV, and a magnetic switch SW operable to open and the close in response to a magnetic field. By this arrangement, the second network 32 provides a second electrical path having a resistance value that is generally dependent on the state of the magnetic switch 32. Either the first network 30 or the second network 32 may include other components such as inductors or capacitors for various purposes such as reducing susceptibility to various forms of electromagnetic energy or reducing the radiation of various forms electromagnetic energy, for example electromagnetic energy in the form of radio waves.

In one embodiment, the magnetic switch SW may be selected so that an open resistance of the magnetic switch is much greater than the first resistance value RPV. For this condition the assembly resistance value when the magnetic switch is open is substantially equal to the first resistor value and thereby indicates that the diagnosable magnetic switch assembly 20 is in the open state. Similarly, the magnetic switch SW may have a closed resistance of the magnetic switch SW that is much smaller than the second resistance value RPS. For this condition the assembly resistance value is substantially equal to the parallel combination of the first resistor value RVP and the second resistor value RVS when the magnetic switch SW is closed, and thereby indicates that the diagnosable magnetic switch assembly 20 is in the closed state. Alternately, the magnetic switch SW open resistance and closed resistance may be such that the open resistance value and/or closed resistance value needs to be included in the characterization of the diagnosable magnetic switch assembly 20, particularly if the open and closed values of the magnetic switch SW vary due to changes in temperature or due to wear.

As used herein, an assembly resistance value substantially equal to a specific resistor value includes a range of values greater than and/or less than the specific resistor value. The range may correspond to the tolerance of the resistor values plus any additional resistance present in the electrical path between the controller 24 and the diagnosable magnetic switch assembly 20. For example, the controller 24 may be connected to the first terminal 26 and the second terminal by wires 34 and 36 through a connector 38 that may contribute to the assembly resistance value measured by the controller 24. An exemplary range of values may be the specific resistor value +/−10%.

The first resistor value RPV and the second resistor value RSV are preferably selected so that the assembly resistance values for the open state and the closed state are readily distinguished from potential fault conditions. Exemplary fault conditions may include, but are not limited to, a short circuit between wires 34 and 36, a short circuit from either wires 34 or 36 to the vehicle chassis ground, an open circuit due to connector 38 being disconnected, or a damaged magnetic switch SW.

By way of an example, suitable resistance values for RPV and RPS may be 2000 Ohms and 500 Ohms, respectively. In this example, the assembly resistance value range will be determined using an exemplary range of +/−10%. As such, the open state will be indicated when the assembly resistance value is about 2000 Ohms+/−10%, or about 1800 Ohms to about 2200 Ohms. Similarly, the closed state will be indicated when the assembly resistance value is about 400 Ohms+/−10%, or about 360 Ohms to about 440 Ohms. If the assembly resistance value is not between about 360 Ohms to about 440 Ohms and not between about 1800 Ohms to about 2200 Ohms, then an assembly fault state may be indicated. It should be evident to those skilled in the art that there are several means available to readily measure the assembly resistance value with the degree of accuracy necessary to determine the various states of the diagnosable magnetic switch assembly 20 described herein.

If an assembly fault state is indicated, the assembly resistance value may be used to further diagnose various conditions such as an open circuit condition, a short circuit condition, and a magnetic switch fault condition. The open circuit condition may be indicated when the assembly resistance value is substantially greater than the first resistance value RPV. Continuing with the exemplary values for RPV and RSV given above, if the assembly resistance value is greater than about 2200 Ohms, then an open circuit condition may be indicated. In response, the controller 24 may output a diagnostic signal 40 directing a technician to check the wires 34 and 36 for damage, and confirm that connector 38 is properly connected. The short circuit condition may be indicated when the assembly resistance value is substantially less than a parallel resistor value equal to the first resistor value RPV and the second resistor value RVS in parallel. For this example, the parallel resistor value is equal to the parallel combination of 2000 Ohms and 500 Ohms, about 400 Ohms. Continuing with the exemplary +/−10% range given above, if the assembly resistance value is less than about 360 Ohms, then a short circuit condition may be indicated. In response, the controller 24 may output a diagnostic signal directing a technician to check the wires 34 and 36 for insulation damage that may be causing the short circuit condition. A magnetic switch fault condition may be indicated when the assembly resistance value is substantially less than the first resistance value RPV and substantially greater than the parallel resistor value of the first resistor value RPV and the second resistor value RSV in parallel. Continuing with the exemplary values for RPV and RSV given above, if the assembly resistance value is greater than about 440 Ohms and less than about 1800 Ohms, then a magnetic switch fault condition may be indicated. In response, the controller 24 may output a diagnostic signal directing a technician to replace the diagnosable magnetic switch assembly 20.

In one embodiment of the diagnosable magnetic switch assembly 20 the magnetic switch SW may include a reed switch. Reed switches are economical and readily available devices that do not require a power supply to operate to an open state or a closed state in response to a magnetic field. In another embodiment of the diagnosable magnetic switch assembly 20 the magnetic switch SW may include a Hall effect switch. Hall effect switches require a power supply to operate to an open state and a closed state in response to a magnetic field, and so the system 10 incurs the additional cost of wiring power to the diagnosable magnetic switch assembly 20. However, programmable Hall effect switches that can be calibrated after being installed into the cushion 14 to switch to open or closed in response to a specific magnetic field strength are readily available from such companies as Micronas and Allegro. Using such a Hall effect switch may allow the seat occupant indicator system 10 to be calibrated after assembly and thereby compensate for variations in the strength of magnetic field generated by magnet 22 and for variations of dimension D1 and D2 for different occupants 18.

FIG. 4 illustrates an embodiment of a method or routine 400 for detecting a seat occupant 18 residing in a seat assembly 12 having a seat occupant indicator system 10. The method 400 may include a step of configuring a diagnosable magnetic switch assembly 20 to operate to an open state and a closed state in response to a magnetic field, and to exhibit an assembly resistance value indicative of at least the open state, a closed state, or an assembly fault state. At step 410, the diagnosable magnetic switch assembly 20 and a magnet 22 are arranged in a seat cushion 14 so as to vary the distance between the diagnosable magnetic switch assembly 20 and the magnet 22 in response to the presence or absence of an occupant 18. Changing the distance generally changes the strength of the magnetic field impinging on the diagnosable magnetic switch assembly 20 in response to the presence of the occupant 18. The magnetic field varies to operate the diagnosable magnetic switch assembly 20 to vary the assembly resistance value and thereby indicate the presence of the seat occupant 18 on the seat cushion 14. At step 420 the assembly resistance value is measured or determined by a controller 24. At step 430 the assembly resistance value is compared to a range of expected resistance values to see if the resistance value is substantially equal to the first resistance value RPV. If the assembly resistance value is substantially equal to the first resistance value RPV, then the method 400 proceeds to step 440 where a signal 40 is output by the controller 24 indicating that the seat assembly 24 is not occupied by a person 18, e.g. the seat assembly 12 is empty. If the assembly resistance value is not substantially equal to the first resistance value RPV, then the method 400 proceeds to step 450 where the assembly resistance value is compared to a parallel resistance value about equal to the parallel combination of the first resistance value RPV and the second resistance value RSV. If the assembly resistance value is substantially equal to the parallel resistance value, then the method 400 proceeds to step 450 where a signal 40 is output by the controller 24 indicating that the seat assembly is occupied by a person 18. If the assembly resistance value is not substantially equal to the parallel resistance value, then the method 400 proceeds to step 470 where a signal 40 is output by controller 24 indicating an assembly fault state and thereby indicating that there may be a problem with the seat occupant indicator system 10. The step 450 of outputting a signal 40 indicating that the assembly fault state is present may include indicating that the assembly fault state is caused by an open circuit condition, a short circuit condition, or a magnetic switch fault condition. As described above, these conditions are determined by comparing the assembly resistance value to the expected resistance values.

Accordingly, a system 10 and method 400 for determining if a seat assembly 12 is occupied by an occupant 18 are provided. The system 10 includes a diagnosable magnetic switch assembly 20 that exhibits an assembly resistance value dependent on the state of the diagnosable magnetic switch assembly 20. In one embodiment, when the system 10 is operating normally, the assembly resistance value is substantially equal to either a first resistance value RPV, thereby indicating an open state, or a parallel resistance value substantially equal to the parallel combination of the first resistance value RPV and a second resistance value RSV, thereby indicating a closed state. If the assembly resistance value is not substantially equal to either the first resistance value RPV or the parallel resistance value, then an assembly fault state may be indicated and a signal may be output indicating that the system 10 should be serviced. By having such an arrangement, the system 10 may more reliably indicate that an occupant 18 is present, or that the seat assembly 12 is empty as compared to systems that do not include electrical components such as RP and RS to provide a switch assembly resistance other than a simple open circuit or short circuit. Furthermore, the system may be embedded or molded within a seat cushion 14 and thereby reduce manufacturing costs associate with installing a switch assembly to a seat frame or other mechanical support.

While this invention has been described in terms of the preferred embodiments thereof, it is not intended to be so limited, but rather only to the extent set forth in the claims that follow.

We claim:

1. A diagnosable magnetic switch assembly comprising:
a first terminal and a second terminal for making electrical contact with the diagnosable magnetic switch assembly;
a first network connected between the first terminal and the second terminal, said first network comprising a first resistor having a first resistor value; and
a second network connected between the first terminal and the second terminal, said second network comprising a series arrangement of a second resistor and a magnetic switch, said second resistor having a second resistor value, said magnetic switch operable to an open state and a closed state in response to a magnetic field corresponding to a proximity of a magnet;
wherein said diagnosable magnetic switch assembly exhibits an assembly resistance value indicative of at least the open state, the closed state, or an assembly fault state.

2. The diagnosable magnetic switch assembly in accordance with claim 1, wherein the assembly resistance value is indicative of
the open state when the assembly resistance value is substantially equal to the first resistor value,
the closed state when the assembly resistance value is substantially equal to the first resistor value and the second resistor value in parallel, and
the assembly fault state when neither the open state nor the closed state is indicated.

3. The diagnosable magnetic switch assembly in accordance with claim 2, wherein the assembly fault state includes an open circuit condition, a short circuit condition, and a magnetic switch fault condition, wherein
said open circuit condition is indicated when the assembly resistance value is substantially greater than the first resistance value,
said short circuit condition is indicated when the assembly resistance value is substantially less than the first resistor value and the second resistor value in parallel, and
said magnetic switch fault condition is indicated when the assembly resistance value is substantially less than the first resistance value and substantially greater than the first resistor value and the second resistor value in parallel.

4. The diagnosable magnetic switch assembly in accordance with claim 1, wherein the magnetic switch comprises a reed switch.

5. The diagnosable magnetic switch assembly in accordance with claim 1, wherein the magnetic switch comprises a Hall effect switch.

6. A seat occupant indicator system comprising:
a seat assembly comprising a cushion formed of compressible material, wherein a compressible region of the cushion is compressed when an occupant is present on the seat assembly;
a diagnosable magnetic switch assembly arranged proximate to the compressible region, said diagnosable magnetic switch assembly operable to an open state and a closed state in response to a magnetic field and configured to exhibit an assembly resistance value indicative of at least an open state, a closed state, or an assembly fault state;
a magnet for providing the magnetic field, said magnet arranged proximate to the diagnosable magnetic switch assembly such that when the compressible region is not compressed, the magnet has a position such that the magnetic field operates the diagnosable magnetic switch assembly to the open state, and when the compressible region is compressed, the magnet has a position such that the magnetic field operates the diagnosable magnetic switch assembly to the closed state; and
a controller configured to determine the assembly resistance value and thereby indicate when a seat occupant is present or an assembly fault state exists.

7. The system in accordance with claim 6, wherein said magnetic switch assembly comprises a first terminal, a second terminal, a first network connected between the first terminal and the second terminal comprising a first resistor having a first resistor value, and a second network connected between the first terminal and the second terminal comprising a series arrangement of a second resistor and a magnetic switch, said second resistor having a second resistor value, said magnetic switch operable to open and the close in response to the magnetic field.

8. The system in accordance with claim 7, wherein the controller is configured to
indicate that the diagnosable magnetic switch assembly is in the open state when the assembly resistance value is substantially equal to the first resistor value,
indicate that the diagnosable magnetic switch assembly is in the closed state when the assembly resistance value is substantially equal to the parallel combination of the first resistor value and the second resistor value, and
indicate a fault condition when neither the open state nor the closed state is indicated.

9. A method of detecting a seat occupant comprising the steps of:
configuring a diagnosable magnetic switch assembly to operate to an open state and a closed state in response to a magnetic field corresponding to a proximity of a magnet and to exhibit an assembly resistance value indicative of at least an open state, a closed state, or an assembly fault state;
arranging the diagnosable magnetic switch assembly and a magnet in a seat cushion to vary the magnetic field effective to operate the diagnosable magnetic switch assembly to detect the presence of a seat occupant on the seat cushion;
determining the assembly resistance value; and
outputting an indication when a seat occupant is present or an assembly fault state exists.

10. The method in accordance with claim 9, further comprising a step of determining if the assembly fault state is an open circuit condition, a short circuit condition, or a magnetic switch fault condition.
